(19) United States
(12) Patent Application Publication
(10) Pub. No.: US 2012/0074688 A1
(43) Pub. Date: Mar. 29, 2012

(54) DRAIN SEAL

(76) Inventors: LINCOLN C. EEKHOFF, ELDORA, IA (US); PAUL T. BRUSS, CEDAR FALLS, IA (US)

(21) Appl. No.: 12/892,196

(22) Filed: Sep. 28, 2010

(51) Int. Cl. F16L 33/16

(52) U.S. Cl. 285/240

(57) ABSTRACT

A seal requiring no compression type clamp is provided for a drain nipple-hose assembly having a tubular tapered drain nipple projecting from a structure to be drained and a corrugated hose for placing over the drain nipple. The seal includes a hollow flexible inner sleeve and a hollow outer sleeve which is longer than the outer sleeve. The seal also includes an annular wall member which joins an end of the inner sleeve to an end of the outer sleeve. The inner sleeve is stretched over the drain nipple between the drain nipple and the hose so that the inner sleeve sealingly engages the drain nipple and the hose. The outer sleeve surrounds an end of the hose. The wall member has a curved sectional shape, which is concave in a direction in which the drain nipple opens to the hose.

### FIELD OF THE INVENTION

The present invention relates to a seal for a drain nipple-hose assembly.

### BACKGROUND OF THE INVENTION

In some off highway vehicles, the heating, ventilation and air conditioning “HVAC” system is in the roof. The HVAC system includes an evaporator which condenses water from the air. This water must be drained from the system. To provide a drain for such water, tapered drain nipples are formed, and drain lines are attached to the drain nipples. Such a nipple may have a hose barb of some type to retain and seal the hose with a clamp. However, a hose barb would require complicated slides in the tools used for molding the roof components. A wire clamp has been used to retain the hose on the nipple. However, if a drain line becomes plugged for some reason, then water will back up and can drain out from between the drain line and the drain nipple. This leakage can soak roof headliners when the drain line cannot flow freely. Sealing such a drain hose to the drain nipple has been a problem.

A seal for a spiral corrugated hose and a cylindrical neck is shown in U.S. Pat. No. 4,763,932, issued in 1988 to Matz et al. However, this seal requires a hose clamp and is not designed to work with a tapered neck. This seal also requires a meticulous threading of the hose into the seal.

A seal for a cylindrical corrugated hose and a cylindrical tube is shown in U.S. Pat. No. 3,408,091, issued in 1966 to Zylstra. This seal is also not designed to work with a tapered neck. In addition, this seal has an outer sleeve which has a cylindrically corrugated inner surface. Because the mating parts are both corrugated, it would be difficult to insert the hose into the seal/coupling.

### SUMMARY

Accordingly, an object of this invention is to provide a seal for such a drain nipple-hose assembly where the nipple is tapered.

Another object of this invention is to provide such a seal which does not require a hose clamp.

Another object of this invention is to provide such a seal which can be quickly and easily be placed over the end of a non-spiral corrugated hose.

These and other objects are achieved by the present invention, wherein a seal is provided for a drain nipple-hose assembly having a tubular tapered drain nipple projecting from a structure to be drained and a hose for placing over the drain nipple. The seal includes a hollow flexible inner sleeve and a hollow outer sleeve which is longer than the outer sleeve. The seal also includes an annular wall member which joins an end of the inner sleeve to an end of the outer sleeve. The inner sleeve is stretched over the drain nipple between the drain nipple and the hose so that the inner sleeve sealingly engages the drain nipple and the hose. The outer sleeve surrounds and is spaced radially apart from an end of the hose. The wall member has a curved sectional shape, which is concave in a direction in which the drain nipple opens to the hose.

### BRIEF DESCRIPTION OF THE DRAWINGS

FIG. 1 is a sectional view of a drain nipple-hose assembly including the drain seal of the present invention; and

FIG. 2 is a perspective view of the seal of FIG. 1.

### DESCRIPTION OF THE PREFERRED EMBODIMENT

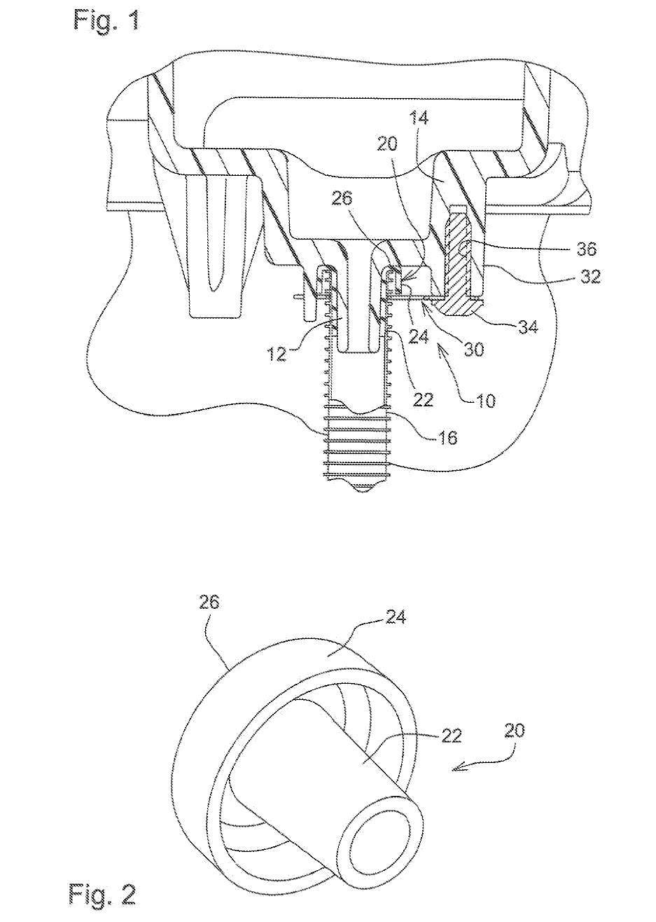

Referring to FIG. 1, a hollow tubular or cylindrical tapered drain nipple 12 projects from a structure 14 to be drained, such as drain pan in a HVAC system (not shown) mounted in the roof (not shown) of a vehicle (not shown). A drain line or hose 16 is placed over the drain nipple 12 and receives fluid from the drain nipple. Drain hose 16 may be a conventional corrugated drain line. The tapering of the drain nipple 12 is such that its outer end has a smaller outer diameter than the diameter of its inner end. This facilitates the removal of a molded structure 14 from its mold (not shown).

Referring to FIGS. 1 and 2, an elastomeric seal 20 includes a flexible body forming a hollow inner sleeve 22, a hollow outer sleeve 24 and an annular wall member 26. Wall member 26 joins an end of the inner sleeve 22 to an end of the outer sleeve 24, and extends therebetween. In section, the wall member 26 is curved and is concave in the direction in which the drain nipple 12 opens to the hose 16.

The inner sleeve 22 preferably has a size or diameter which is smaller than the diameter of the nipple 12, so that when it is mounted over the drain nipple 12, it will be expanded or stretched over the drain nipple 12. Sleeve 22 will therefore be between the drain nipple 12 and the hose 16 so that an inner surface of the inner sleeve 22 sealingly engages the drain nipple 12 and an outer surface of the inner sleeve 22 sealingly engages the hose 16. The outer sleeve 24 surrounds an end of the hose 16. The outer sleeve 24 is cylindrical and has a uniform inner diameter which is larger than the outer diameter of the hose 16, and is therefore spaced radially outwardly from the outer surface of the hose 16. The inner sleeve 22 is preferably longer than the outer sleeve 24.

The hose 16 is preferably held in place by a known spring retainer or clip 30 which is held to a boss 32 on the structure 14 by a bolt 34 which is screwed into a threaded bore 36 formed in the boss 32. A portion of the clip is received by one of the grooves in the corrugated hose 16 so that the clip 30 prevents the seal 20 and hose 16 from moving axially away from the drain nipple 12. But, the clip 30 does not radially compress the hose 16 or the seal 20, and no hose or compression type clamp is required.

This elastomeric seal 20 can easily and simply be placed over the end of the hose 26. Then it expands over the drain nipple 12 inside the hose 16 to form a seal between the nipple 12 and the hose 16. No fittings or hose clamps are required, and the hose 16 can be cut off crookedly and it will still be sealed. This seal 20 is simple to install and requires no additional tools. With this seal 20 in place, if the drain line 16 becomes plugged for some reason, water will back up into the structure 14 and drain out through another drain line (not shown). Without the seal 20, there is no seal between the drain nipple 12 and drain line 16, and water may leak out of the top of the hose 16. The outer sleeve 24 and the wall member 26 prevent the seal 20 from being pulled into the hose 16 during installation. That is, as the hose 16 is pushed on the nipple 12, the friction tends to push the seal 20 into the hose 16 rather than stretch it over the nipple 12. The outer sleeve 24 and the wall member 26 prevent this from happening.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A clampless seal for a drain nipple-hose assembly having a tubular tapered drain nipple projecting downwardly from a structure to be drained and a hose for placing over the drain nipple, the seal comprising:
a hollow flexible inner sleeve having an uninstalled diameter which is smaller than a diameter of the drain nipple;
a hollow cylindrical outer sleeve having a uniform inner diameter which is larger than an outer diameter of the hose; and
an annular wall member extending from an end of the inner sleeve to an end of the outer sleeve, the inner sleeve being stretchable over the drain nipple between the drain nipple and the hose so that the inner sleeve sealingly engages the drain nipple and the hose, and so that the outer sleeve surrounds and is spaced apart from an end of the hose.

2. The seal of claim 1, wherein:
the inner sleeve is longer than the outer sleeve.

3. The seal of claim 2, wherein:
the wall member has a curved sectional shape.

4. The seal of claim 2, wherein:
the wall member has a curved sectional shape which is concave in a direction in which the drain nipple opens to the hose.

5. A clampless seal for a drain nipple-hose assembly having a tubular tapered drain nipple projecting downwardly from a structure to be drained and a hose for placing over the drain nipple, the seal comprising:
a hollow flexible inner sleeve, the inner sleeve having a size so that, when mounted over the drain nipple, the inner sleeve it will be expanded and stretched over the drain nipple, and so that the inner sleeve sealingly engages the drain nipple and the hose;
a hollow cylindrical outer sleeve, the outer sleeve being spaced apart from and surrounding an end of the hose; and
an annular flexible wall member extending from an end of the inner sleeve to an end of the outer sleeve, the wall member having a curved sectional shape which is concave in a direction in which the drain nipple opens to the hose.

6. A clampless seal for sealing between a hollow tapered downwardly projecting drain nipple and a hose, the seal comprising:
a flexible body forming a hollow inner sleeve, a hollow outer sleeve and an annular wall member, the wall member joining an end of the inner sleeve to an end of the outer sleeve;
the inner sleeve having an inner surface which sealingly engages the drain nipple and an outer surface which sealingly engages the hose;
the outer sleeve being spaced apart from and surrounding an end of the hose; and
an annular wall member joining the inner sleeve to the outer sleeve, the inner sleeve being stretched over the drain nipple between the drain nipple and the hose so that the inner sleeve sealingly engages the drain nipple and the hose, and the wall member having a sectional shape which is concave in a direction in which the drain nipple opens to the hose.

7. A clampless drain/hose seal assembly, comprising:
a tubular tapered drain nipple projecting downwardly from a structure to be drained of fluid;
a hose for placing over the drain nipple and receiving fluid from the drain nipple;
a seal comprising a flexible body, the body comprising:
a hollow flexible inner sleeve, the inner sleeve having a size so that, when mounted over the drain nipple, the inner sleeve it will be expanded and stretched over the drain nipple, and so that the inner sleeve sealingly engages the drain nipple and the hose;
a hollow outer sleeve, the outer sleeve being spaced radially apart from and surrounding an end of the hose; and
an annular flexible wall member extending from an end of the inner sleeve to an end of the outer sleeve, the wall member having a curved sectional shape which is concave in a direction in which the drain nipple opens to the hose; and
a wire retainer for preventing the hose from moving axially away from the drain nipple.
